(19) United States
(12) Patent Application Publication
(10) Pub. No.: US 2008/0106616 A1
(43) Pub. Date: May 8, 2008

(54) Image taking device with removable optical unit

(76) Inventors: Hideki Nagata, Hachioji-shi (JP); Minoru Omaki, Kunitachi-shi (JP); Hirofumi Tsuchida, Kunitachi-shi (JP); Toshiyuki Nagaoka, Akishima-shi (JP)

Correspondence Address: KENYON & KENYON LLP, ONE BROADWAY, NEW YORK, NY, 10004, US

(21) Appl. No.: 11/901,995

(22) Filed: Sep. 19, 2007

(30) Foreign Application Priority Data
Sep. 26, 2006 (JP) 2006-260324

(51) Int. Cl. H04N 5/76

(52) U.S. Cl. 348/231.99

(57) ABSTRACT

There is provided an image taking device with removable optical unit, with which it is possible to switch the operating mode of an image taking device body to playback mode without operating an image playback button or the like, and operation of the image taking device body is made easy. There are provided an image taking device body, a lens unit (optical unit) that is removable with respect to the image taking device body, an removal detection unit for detecting removal of the lens unit from the image taking device body, and a system controller (control unit) for controlling operation of the image taking device body. The image taking device body is provided with an image playback function. The system controller is configured to switch the operating mode of the image taking device body to playback mode upon detection of removal of the lens unit from the image taking device body by the removal detection unit.

### BACKGROUND OF THE INVENTION

1. Field of the Invention

The present invention relates to an image taking device constructed having an optical unit that is removable with respect to an image taking device body.

This application is based on Japanese Patent Application No. 2006-260324, the content of which is incorporated herein by reference.

2. Description of Related Art

Conventionally, many digital still cameras are provided with an image display function, and have an image playback function for displaying images that have been taken by the camera (for example, Japanese Unexamined Patent Application, Publication No. 11-341514).

Normally, in the case of using an image playback function, the user of a digital still camera will input an image playback command to the digital still camera by either operating a single-function image playback button provided on the camera body, or operating a general purpose operation button in accordance with a message displayed by an image display function of the digital still camera.

### BRIEF SUMMARY OF THE INVENTION

A first aspect of the present invention is an image taking device with removable optical unit, comprising:

an image taking device body;

an optical unit that is detachable with respect to the image taking device body;

a removal detection unit for detecting removal of the optical unit from the image taking device body; and

a control unit for controlling operation of the image taking device body, wherein

the image taking device body is provided with a storage unit for storing acquired image information and an image display unit, and is provided with an image playback function for displaying image information on the image display unit; and

the control unit switches an operating mode of the image taking device body to playback mode when removal of the optical unit from the image taking device body has been detected by the removal detection unit.

A second aspect of the present invention is an image taking device with removable optical unit, comprising:

an image taking device body;

an optical unit that is detachable with respect to the image taking device body;

a removal detection unit for detecting removal of the optical unit from the image taking device body; and

a control unit for controlling operation of the image taking device body, wherein

the image taking device body comprises a storage section for storing acquired image information, and

an image display section for displaying the image information stored in the storage unit, and

the control unit controls the storage unit and the image display unit when removal of the optical unit from the image taking device body has been detected by the removal detection unit, so as to display the image information stored in the storage unit on the image display unit.

### BRIEF DESCRIPTION OF THE SEVERAL VIEWS OF THE DRAWINGS

FIG. 1 is a perspective drawing showing the structure of a digital still camera (image taking device with removable optical unit) of a first embodiment.

FIG. 2 is a block diagram showing the structure of a digital still camera of a first embodiment.

FIG. 3 is a drawing showing the appearance of operation of a power supply of the image taking device body of the digital still camera of the first embodiment.

FIG. 4 is a drawing showing the appearance of operation of a power supply of the image taking device body of the digital still camera of the first embodiment.

FIG. 5 is a drawing showing the appearance of a mode switching operation of the image taking device body of the digital still camera of the first embodiment.

FIG. 6 is a drawing showing the appearance of a mode switching operation of the image taking device body of the digital still camera of the first embodiment.

FIG. 7 is a drawing showing the structure of a digital still camera of a second embodiment, and the appearance of a mode switching operation of the image taking device body.

FIG. 8 is a drawing showing the appearance of a mode switching operation of the image taking device body of the digital still camera of the second embodiment.

FIG. 9 is a drawing showing the appearance of a mode switching operation of the image taking device body of the digital still camera of the second embodiment.

FIG. 10 is a drawing showing the structure of a digital still camera of a third embodiment, and the appearance of a mode switching operation of the image taking device body.

FIG. 11 is a drawing showing the appearance of a mode switching operation of the image taking device body of the digital still camera of the third embodiment.

FIG. 12 is a drawing showing the appearance of a mode switching operation of the image taking device body of the digital still camera of the third embodiment.

### DETAILED DESCRIPTION OF THE INVENTION

An image taking device with removable optical unit of the present invention, comprises an image taking device body, an optical unit that is detachable with respect to the image taking device body, a removal detection unit for detecting removal of the optical unit from the image taking device body, and a control unit for controlling operation of the image taking device body, wherein the image taking device body is provided with a storage unit for storing acquired image information and an image display unit, and is provided with an image playback function for displaying image information on the image display unit, and the control unit switches an operating mode of the image taking device body to playback mode when removal of the optical unit from the image taking device body has been detected by the removal detection unit.

With the image taking device with a removable optical unit constructed in this way, by removing the optical unit from the image taking device body, removal of the optical unit is detected by the removal detection unit. If removal of the optical unit is detected by the removal detection unit, the control unit switches the operating mode of the image taking device body to playback mode.

Also, another image taking device with removable optical unit of the present invention comprises an image taking device body, an optical unit that is detachable with respect to the image taking device body, a removal detection unit for detecting removal of the optical unit from the image taking device body, and a control unit for controlling operation of the image taking device body, wherein the image taking device body comprises a storage section for storing acquired image information, and an image display section for displaying the image information stored in the storage unit, and the control unit controls the storage unit and the image display unit when removal of the optical unit from the image taking device body has been detected by the removal detection unit, so as to display the image information stored in the storage unit on the image display unit.

With the image taking device with a removable optical unit constructed in this way, by removing the optical unit from the image taking device body, removal of the optical unit is detected by the removal detection unit. If removal of the optical unit is detected by the removal detection unit, the control unit controls operation of the storage unit and the image display unit so as to display image information stored in the storage unit on the image display unit.

Operations such as removing the optical unit from the image taking device body are carried out at the user's discretion after they have finished taking pictures. Therefore, by adopting this type of structure where operating mode of the image taking device is switched to playback mode upon removal of the optical unit from the image taking device body, or where image information being stored in the storage unit is displayed on the image display unit upon removal of the optical unit from the image taking device body, it is possible to switch the operating mode of the image taking device body to playback mode or cause display of the image information stored in the storage unit on the image display device in accordance with the users intentions, without having to operate an image playback button etc. Specifically, with the above-described image taking device having a removable optical unit it is possible to omit an image playback button.

Also, while attempting to reduce the size of the image taking device, in order to maintain the operability of the device it is necessary to secure sufficient installation space for the various switches in the image taking device body.

With this image taking device with removable optical unit, since there is no need to provide an image playback button, as descried above, there is no need to secure installation space for the image playback button in the image taking device body.

In this way, because it is possible to secure installation space for various operation switches, it is possible to maintain operability without miniaturizing the various operating switches while attempting to additionally reduce the size of the image taking device body, and to expect improved operability with imaginative layout of various operating switches.

Of the structural members of the image taking device, because of the characteristics of the optical unit it is difficult to reduce the optical unit in size. Specifically, even if the image taking device is made small in size, the optical unit takes up a comparatively large volume of the overall image taking device. It is therefore easy to discriminate the optical unit even by touch.

With the above described image taking device with removable optical unit, by operating an optical unit that is easily discernible even by touch, it is possible to switch the operating mode of the image taking body to playback mode, or cause display of image information stored in the storage unit on the image display unit. Therefore, with the above-described image taking device with removable optical unit, compared to cases such as operating an image playback button or the like after visually confirming the position of the image playback button, operating an image playback button located by touch, or operating a general purpose operating button in accordance with messages displayed by an image display function of the image taking device, it is possible to rapidly switch the operating mode of the image taking device body to playback mode, or to rapidly display image information that is stored in the storage unit on the image display unit.

The term image taking device used here can be a configuration where it initially becomes possible to take picture upon attaching a removable optical unit. Also, the image taking device can refer to a structure where an imaging optical system configured to be able to take pictures on a stand alone basis is incorporated, and image taking functions are expanded by the attachment of a removable optical unit.

Here, in the case of taking pictures with the image taking device, confirmation as to whether or not the acquired image information is good is generally carried out immediately after taking pictures. Specifically, among the image information stored in the storage unit of the image taking device, the frequency of browsing the image information most recently stored is high.

Therefore, in the above described image taking device with removable optical unit, it is possible to have a structure where, among the image information stored in the storage unit, the control unit displays the most recently stored image information on the image display unit at the point in time when removal of the optical unit from the image taking device body has been detected by the removal detection unit.

In this case, when switching to playback mode, or when carrying out display of the image information stored in the storage unit, image information that has an extremely high frequency of browsing is displayed first. In this way, in many cases it is possible to omit a selection operation for image information that will be the object of display when displaying image information on the image display unit, and it is possible to simplify the operation of the image taking device body.

Also, with the above-described image taking device with a removable optical unit, it is possible to have a structure where the removal detection unit has a first detection switch provided at a position facing the optical unit of the image taking body at the time of attachment to the image taking device body, to perform ON/OFF switching.

In this case, since removal of the optical unit from the image taking device body is detected based on the on/off state of the first detection switch, the structure of the removal detection unit is simplified and the manufacturing cost is reduced.

Also, the first detection switch is provided in the image taking device body at a position facing the optical unit at the time of attachment of the optical unit to the image taking body. Specifically, the first detection switch is provided inside the image taking device body, at a position obscured by the optical unit at the time of attachment of the optical unit (dead space). Therefore, even if the first detection switch is provided, no installation space for other switches is sacrificed in the image taking device body, and it is possible to maintain operability.

It is also possible to have a structure where, in the above-described image taking device with a removable optical unit, the optical unit is capable of relative rotation with respect to the image taking device body in a state attached to the image taking device body, a displacement detection unit is provided for detecting relative rotation of the optical unit with respect to the image taking device body in a state attached to the image taking device body, and the displacement detection unit detects at least one of relative rotation amount and rotation direction of the optical unit with respect to the image taking device body.

In this case, after the optical unit has been attached to the image taking device body and the power supply of the image taking device is turned on, by relatively rotating the optical unit with respect to the image taking device body, this rotation is detected in the displacement detection unit. If relative rotation of the optical unit with respect to the image taking device body is detected by the displacement detection unit, the control unit switches the operating mode of the image taking device body.

In this way, it is possible to perform switching of the operating mode of the image taking device body without operating a mode changing switch. Specifically, it is possible to omit the mode changing switch in this case.

Also, the user retains the image taking device body and the optical unit when the optical unit is attached to the image taking device body. Therefore, after carrying out an operation to attach the optical unit to the image taking device body, the user can speedily cause relative rotation of the image taking device body and the optical unit without repositioning the image taking device with removable optical unit. Specifically, the user can perform a switching operation to a desired operating mode (for example, exposure conditions setting mode) seamlessly with an operation of attaching the optical unit to the image taking device body. With the above described image taking device with removable optical unit, therefore, compared to the case where the image taking device with removable optical unit is repositioned after attaching the optical unit to the image taking device body and then operating a mode change switch etc. it is possible to smoothly carry out the operation of the image taking device with removable optical unit.

In this case, it is possible to carry out operation mode switching for the image taking device body by rotating the optical unit relative to the image taking device body. Here, as a structure allowing relative rotation of the optical unit with respect to the image taking device body, it is possible to adopt a structure where the optical unit rotates around its optical axis. In this case, since it is possible to perform switching of the operating mode of the image taking device body without shifting the optical axis of the optical unit, it is possible to take pictures immediately when transferring to picture taking mode.

It is also possible to have a structure where, in the above-described image taking device with a removable optical unit, the displacement detection unit is provided with a roller that is in contact with the optical unit, in a state where the optical unit is attached to the image taking device body, and rotates according to relative rotation of the optical unit with respect to the image taking device body, and a rotation detection unit for detecting information of at least one of rotation amount and rotation direction of the roller, and the displacement detection unit detects relative rotation of the optical unit with respect to the image taking device body based on the information of at least one of the rotation amount and rotation direction of the roller detected by the rotation detection unit.

In this case, the optical unit is in contact with the roller in a state where the optical unit is attached to the image taking device body. This roller rotates in accordance with relative rotation between the image taking device body and the optical unit. Information on at least one of the rotation amount and rotation direction of the roller at this time is detected by the rotation detection unit. The displacement detecting unit detects relative rotation of the optical unit with respect to the image taking device body based on the information on at least one of the rotation amount and rotation direction of the roller that has been detected by the rotation detection unit.

The roller is provided in the image taking device body at a position facing the optical unit at the time of attachment of the optical unit to the image taking device body. Specifically, the roller is provided at a position that is obscured by the optical unit at the time the optical unit is attached (dead space), which means that even if the roller is provided it is possible to maintain operability without sacrificing installation space for other operating switches etc. in the image taking device body.

It is also possible to have a structure where, in the above-described image taking device with a removable optical unit, the displacement detection unit has a second detection switch that is switched on and off by relative rotation of the optical unit with respect to the image taking device body in a state attached to the image taking device body, and the displacement detection unit detects relative rotation of the optical unit with respect to the image taking device body based on the ON/OFF state of the second detection switch.

In this case, since relative rotation of the optical unit with respect to the image taking device body is detected based on the on/off state of the second switch, the structure of the displacement detection unit is simplified and the manufacturing cost is reduced.

Also, the second detection switch is provided in the image taking device body at a position facing the optical unit at the time of attachment of the optical unit to the image taking body. Specifically, the second detection switch is provided inside the image taking device body, at a position obscured by the optical unit at the time of attachment of the optical unit (dead space). Therefore, even if the second detection switch is provided, no installation space for other switches is sacrificed in the image taking device body, and it is possible to maintain operability.

Here, it is also possible to have a structure where a plurality of second detection switches are provided in the image taking device body, with an on/off pattern of these second detection switches being changed in accordance with amount of relative rotation of the optical unit with respect to the image taking device body, and the displacement detection unit detects relative rotation of the optical unit with respect to the image taking device body based on the on/off pattern of these second detection switches.

In this case, a plurality of on/off patterns of the second detection switches are prepared, and it is possible to carry out switching of operating modes between three or more operating modes by making respective operating modes correspond to each pattern.

It is also possible, with the above described image taking device having a removable optical unit, to have a structure where the image taking device body has a timer for measuring time, and the control unit turns the power supply of the image taking device body OFF at a point in time where the timer has counted a reference time from the point in time when removal of the optical unit from the image taking device body was detected by the removal detecting unit.

In this case, after the user switches the operating mode of the image taking device body to playback mode, or displays image information on the image display device, since the power supply of the image taking device body is turned off after a specified reference time has elapsed from the point in time where removal of the optical unit from the image taking device body was detected, even if operation of the image taking device is not carried out, it is possible to suppress power consumption, and it is possible to extend the operating time. With the above-described image taking device with removable optical unit, it is also possible to have a non-volatile image display unit for holding display content when power is not being supplied to the image display unit.

In this case, the image display unit maintains display content without consuming power after once displaying image information, which means that it is possible to suppress power supply consumption at the time of playback mode, and it is possible to prolong the operating time.

Here, it is possible to use electronic paper, for example, as a non-volatile image display unit. As the electronic paper it is possible to use the twisting ball system, electrophoresis system, magnetic migration system, electric powder and granular material system, electrified toner type display system, liquid crystal display system, electrolytic deposition system, electrochromic system, actuated film system or any other arbitrary system. According to the above described image talking device with removable optical unit, since it is possible to switch the operating mode of the image taking device body to playback mode in accordance with the user's wishes without operating an image playback button or the like, operation of the image taking device body becomes easy.

Embodiments will be described in the following using the drawings.

### FIRST EMBODIMENT

With this embodiment, an example of an image taking device with removable optical unit applied to a digital still camera will be described.

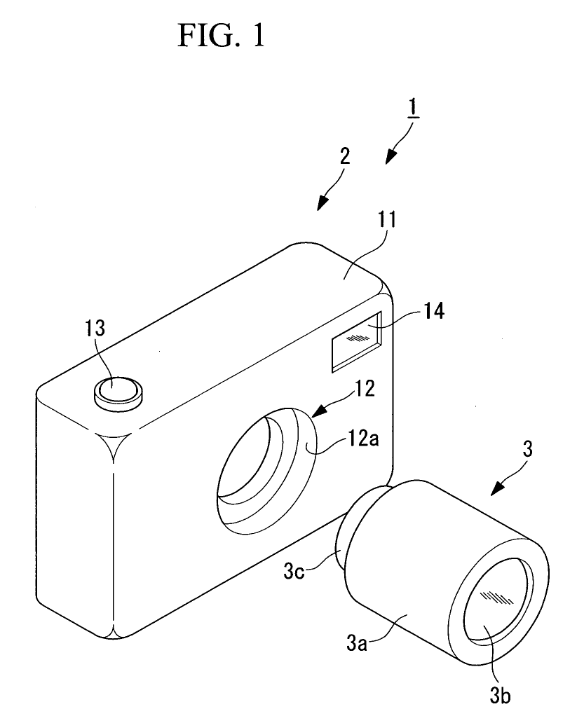

As shown in the perspective drawing of FIG. 1, a digital still camera 1 (imaging device with removable optical unit) comprises an image taking device body 2, and a lens unit 3 (optical unit) that is removable with respect to the imaging device body 2.

Here, with this embodiment, the image taking device body 2 is configured to be initially capable of taking pictures as a result of attaching the lens unit 3. Incidentally, the image taking device body 2 can also be a structure where an imaging optical system configured to be able to take pictures on a stand alone basis is incorporated, and image taking functions are expanded by the attachment of the lens unit 3. As shown in FIG. 1, the image taking device body 2 has a casing 11 defining a box shape. An opening section 12 linking to the inside of the casing 11 is provided in the front surface side of the casing 11. The inner surface of the opening section 12 is a cylindrical surface, and an expanded diameter section 12a is provided at an end section of the outer surface side of the cylinder.

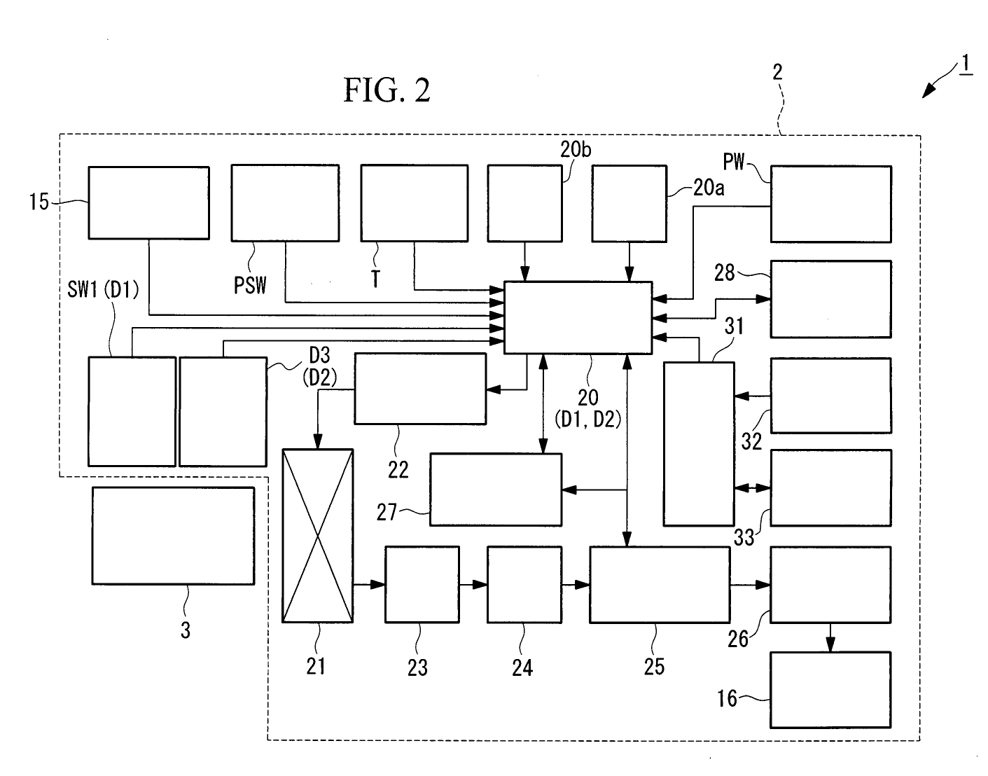

Also, various operation switches 13 such as a release switch and a power supply switch, and a strobe light section 14 etc., are provided on the outer surface of the casing 11. Further, an image information display panel for displaying various image information, and indicator lamps 15 (refer to the block diagram of FIG. 2) for representing various information such as the status of the image taking device body 2, etc. are provided on the outer surface of the casing 11.

Here, as shown in FIG. 2, a non-volatile image display unit 16 for holding display content without power being supplied is used as an image display panel.

The non-volatile image display unit 16 maintains display content without consuming power after once displaying image information, which means that it is possible to suppress power supply consumption by the image taking device body 2 at the time of playback mode, and it is possible to prolong the operating time.

It is possible to use electronic paper, for example, as the non-volatile image display unit 16. As the electronic paper it is possible to use the twisting ball system, electrophoresis system, magnetic migration system, electronic powder and granular material system, electrified toner type display system, liquid crystal display system, electrolytic deposition system, electrochromic system, actuated film system or any other arbitrary system.

Incidentally, instead of the above described non-volatile image display unit 16, it is possible to use an arbitrary structure such as, for example, an LCD (Liquid Crystal Display) panel, or an organic or inorganic EL (electroluminescence) display panel, as an image information display panel.

As shown in FIG. 1, the lens unit 3 has a substantially cylindrical lens housing 3a, and an optical lens 3b provided inside the lens housing 3a. An attachment section 3c for attachment to the image taking device body 2 is provided at one end of the lens housing 3a.

The attachment section 3c is formed into a cylinder that is substantially coaxial with the lens housing 3a.

The outer diameter of the attachment section 3c is made slightly smaller than the inner diameter of the expanded diameter section 12a, and it is possible to insert this attachment section 3c into the expanded diameter section 12a.

The lens unit 3 is removably attached to the casing 11 by engaging the attachment section 3c in the expanded diameter section 12a, or fixed to the casing 11 using a not shown fixing unit. With this embodiment, the lens unit 3 is fixed to the casing 11 by an adsorption fixing unit that uses a magnet.

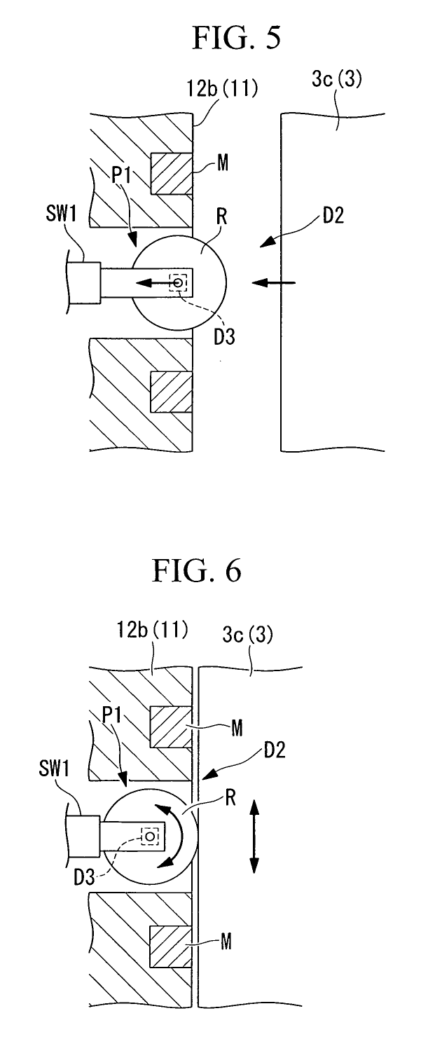

Specifically, as shown in FIG. 5, as a fixing device, a magnet M is provided on a member of one of the casing 11 and the lens unit 3, and a magnet or magnetic material is provided on the other member, and the lens unit 3 is fixed to the casing 11 by adsorptive power of the magnet M. In FIG. 5, an example is shown where the magnet M is provided on the casing 11, and at least a part of the attachment section 3c of the lens unit 3 that contacts the casing 11 is itself constructed using a magnetic material.

Here, as the fixing unit it is possible to use any other configuration besides the adsorption type fixing device that uses a magnet, as described above, such as, for example, a bayonet type fixing device or a screw-in type fixing device.

The lens unit 3 is capable of relative rotation with respect to the image taking device body 2 in a state attached to the image taking device body 2. With this embodiment, the image taking device body 2 and the lens unit 3 are capable of relative rotation about the optical axis of the lens unit 3 (namely about the axis of the lens housing 3a).

The overall structure of the image taking device body 2 will be described in the following.

The image taking device body 2 comprises a power supply unit PW for supplying power to each of the devices constituting the image taking device body 2, a power supply switch PSW, a system controller 20 (control unit) constituted by a CPU (central processing unit), and for carrying out control of each part of the digital still camera 1, a ROM 20a previously loaded with programs for control sequences for controlling operations of the system controller 20 and various control parameters etc., RAM 20b used as a work area for temporarily storing data required in implementing various sequences by the system controller 20, and a timer T for measuring time.

Also, an removal detection unit D1 for detecting removal of the lens unit 3 from the image taking device body 2, and a displacement detection unit D2 for detecting relative rotation of the lens unit 3 with respect to the image taking device body 2 in a state attached to the image taking device body 2, are provided in the image taking device body 2.

If the power supply switch PSW is operated by the user, the system controller 20 controls operation of the power supply unit PW on the basis of this operation to control supply of power to each device constituting the image taking device body 2.

Specifically, if the power supply switch PSW is turned ON, the system controller 20 turns the power supply of the image taking body 2 on (carries out supply of power to each device from the power supply unit PW). Also, if the power supply switch PSW is turned OFF, the system controller 20 turns the power supply of the image taking body 2 off (supplies power from the power supply unit PW to only the system controller 20 and the power supply switch PSW).

Also, the system controller 20 carries out predetermined processing by reading out programs and parameters from the ROM 20a once the power supply of the image taking device body 20 is turned on. In this way, the systems of the digital still camera 1 are launched, and electrically a picture taking possible state is entered.

Here, the image taking device body 2 has a plurality of operating modes. As operating modes of the image taking device body 2, in addition to a photographing mode, for example, it is possible to provide a playback mode for displaying taken images etc. on the non-volatile image display unit 16, a setting mode for carrying out various operation settings of the image taking device body 2, and arbitrary operating modes.

With the power supply of the image taking device body 2 in an on state, the system controller 20 switches the operating modes of the image taking device body 2 based on information relating to whether or not the lens unit 3 has been removed from the image taking device body from the removal detection unit D1, and information of at least one of relative rotation amount and rotation direction of the lens unit 3 with respect to the image taking device body 2 detected by the displacement detection unit D2. In other words, the system controller 20 is configured to switch the operating modes of the image taking device body 2 based on detection result of the removal detection unit D1 and the displacement detection unit D2. Specifically, the system controller 20 switches the operating mode of the image taking device body 2 to playback mode upon detection of removal of the lens unit 3 from the image taking device body 2 by the removal detection unit D1.

Incidentally, when removal of the lens unit 3 from the image taking device body 2 has been detected by the removal detection unit D1, the system controller 20, instead of carrying out mode switching, can also be configured to control operation of an external storage unit, such as a flash memory 28 that will be described later, and the non-volatile image display unit 16, to display image information being stored in the external storage unit on the non-volatile image display unit 16.

Also, the system controller 20 switches the operating mode of the image taking device body 2 to photographing mode in a state where removal of the lens unit 3 from the image taking device body 2 has not been detected by the removal detection unit D1.

The system controller 20 is also configured turn the power supply of the image taking device body 2 off at a point in time where the time T measures a reference time from the time when removal of the lens unit 3 from the image taking device body 2 was detected by the removal detection unit D1.

In this way, after the user switches the operating mode of the image taking device body 2 to playback mode, since the power supply of the image taking device body 2 is turned off after a predetermined reference time has elapsed from switching of the operating mode of the image taking device body 2 to playback mode, even if the user neglects to operate the image taking device body 2, it is possible to suppress power consumption, and it is possible to extend the operating time.

Incidentally, the length of the reference time can be made arbitrary.

The structure of the removal detection unit D1 and the displacement detection unit D2 will be described in detail in the following.

In the image taking device body 2, a first detection switch SW1 that is switched on and off by the lens unit 3 at the time of attachment of the lens unit 3 to the image taking device body 2 is provided at a position facing the lens unit 3 at the time of attachment of the lens unit 3.

The system controller 20 is configured to detect removal of the lens unit 3 from the image taking device body 2 based on the on/off state of the first detection switch SW1. Specifically, the first detection switch SW1 and the system controller 20 constitute a removal detection unit D1.

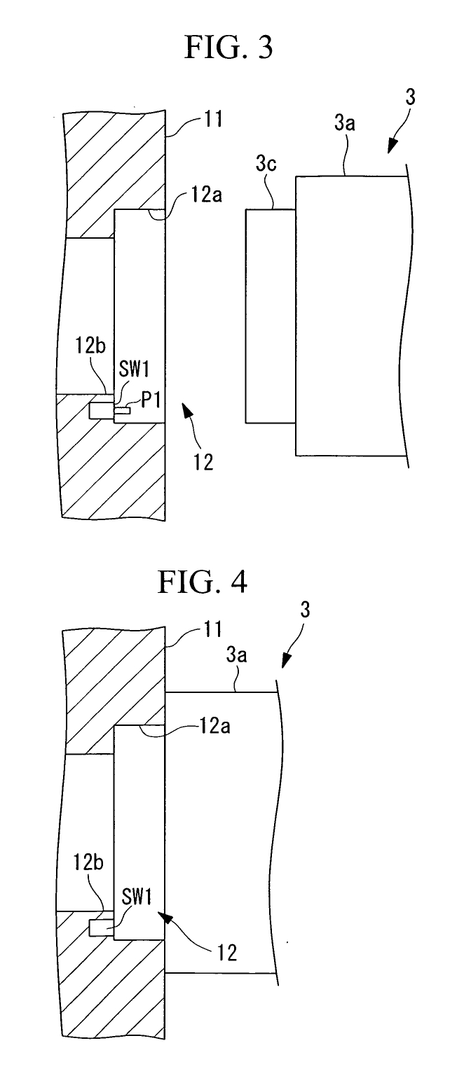

With this embodiment, as shown in FIG. 3 and FIG. 4, the first detection switch SW1 is constructed using a push switch provided in a stepped section 12b formed at a rear end of an expanded diameter section 12a, inside an opening section 12 of the image taking device body 2. The first detection switch SW1 is recessed in the stepped section 12b so that a section to be operated P1 is positioned in the opening direction of the opening section 12. In this way, if the attachment section 3a of the lens unit 3 is inserted into the expanded diameter section 12a, as shown in FIG. 4, the section to be operated P1 is pressed by the leading surface of the attachment section 3a, and the on/off state of the first detection switch SW1 is switched.

Also with this embodiment, as shown in FIG. 5 and FIG. 6, a roller R that contacts the lens unit 3 in a state where the lens unit 3 is attached and is rotated in accordance with relative rotation of the lens unit 3 with respect to the image taking device body 2, and a rotation detection unit D3 for detecting information of at least one of rotation amount and rotation direction of the roller R, are provided in the image taking device body 2. It is possible to adopt an arbitrary structure, such as a rotary encoder, for example, as the rotation detection unit D3.

The system controller 20 is configured to detect relative rotation of the lens unit 3 with respect to the image taking device body 2, based on the information of at least one of the rotation amount and rotation direction of the roller R that has been detected by the rotation detection unit D3. Specifically, the roller R, rotation detection unit D3 and the system controller 20 constitute a displacement detection unit D2.

With this embodiment, as shown in FIG. 5, the roller R constitutes part of the section to be operated P1 of the first detection switch SW1, and is capable of rotating about an axis that is substantially orthogonal to the attachment direction of the lens unit 3 to the image taking device body 2. In this way, as shown in FIG. 6, in a state where the lens unit 3 is attached to the image taking device body 2, the roller R is pressed by the attachment section 3a of the lens unit 3, together with the section to be operated P1 of the first detection switch SW1. In this state, the on/off state of the first detection switch SW1 is switched, and the roller R comes into contact with the leading surface of the attachment section 3a of the lens unit 3.

In this state, if the image taking device body 2 and the lens unit 3 are relatively rotated about the optical axis of the lens unit 3, the roller R rotates with them. At least one of the rotation amount and rotation direction of the roller R at this time is detected by the rotation detection unit D3. The displacement detection unit D2 then detects relative rotation of the lens unit 3 with respect to the image taking device body 2 upon detection of rotation amount and rotation direction of the roller R by the rotation detection unit D3.

The detailed structure of the image taking device body 2 will be described in the following.

As shown in FIG. 2, an image sensor 21 is arranged in the image taking device body 2, at the rear of the lens unit 3. In this way, a subject image is formed on the light receiving area of the image sensor 21 by the lens unit 3.

It is possible to adopt an arbitrary sensor as the image sensor 21, such as a sensor using CCD (charge Coupled Devices) or a sensor using CMOS (Complimentary Metal Oxide Semiconductor). With this embodiment, an image sensor using CCD is used as the image sensor 21.

A CCD driver 22 for driving the image sensor 21 is provided in the image taking device body 2. In this way, the image sensor 21 converts an optical subject image acquired by means of the lens unit 3 to an electrical image signal, and outputs the electrical image signal.

An amplifier 23 for amplifying the image signal output by the image sensor 21, and an A/D converter 24 for digitally converting the output of the amplifier 23, are provided in the image taking device body 2.

Tiny micro color filters for R, G and B are arranged in a matrix shape on the light receiving surface of the image sensor 21. A photographing signal. serially output from the image sensor 21 for each color corresponding to each micro color filter is amplified to an appropriate level by the amplifier 23, and then digitally converted by the A/D converter 24 and made into respective pixel data for red, green and blue.

A data processing circuit 25 for performing various data processing, such as white balance adjustment and gamma correction for the image data acquired by the image sensor 21, and a display unit driver 26 for displaying the image data that has been subjected to processing by the data processing circuit 25 on the non-volatile image display unit 16 as image information, are provided in the image taking device body 2. In the event that the image taking device body 2 is in photographing mode, image data from the A/D converter 24 is input to the data processing circuit 25, image data for a single image portion that has been subjected to necessary processing by this data processing circuit 25 is sent to the display unit driver 26 one after the other. In this way, a subject image being taken is displayed on the non-volatile image display unit 16. Incidentally, when in photographing mode, the system controller 20 is capable of switching to display mode for displaying an image being taken by the image sensor 21 on the non-volatile image display unit 16, and non-display mode where an image being photographed is not displayed on the non-volatile image display unit 16.

Also, an AE processing circuit 27 for carrying out automatic exposure control (AE control) at the time of photography is provided in the image taking device body 2. Image data from the data processing circuit 25 is also sent to the AE processing circuit 27. This AE processing circuit 27 calculates a photometry value for subject brightness of the image sensor 21 based on respectively input image data, and charge accumulation time of the image sensor 21 set in the CCD driver 22 at that point in time, namely, the shutter speed of an electronic shutter. The system controller 20 then determines a new shutter speed of the electronic shutter based on this photometry value, and feeds back this shutter speed to the CCD driver 22, to thus adjust drive of the image sensor 21 and carry out AE control.

As described above, with this digital camera 1, subject brightness is determined using a TTL (Through The Lens) photometry method with the image sensor 21 as a light receiving sensor. It is also possible to change aperture value together with shutter speed of the electronic shutter. If the aperture value is changed, obviously a photometry value is calculated according to subject brightness with aperture value added.

An external storage unit for storing image data output from the data processing circuit 25 is provided in the image taking device body 2. In this embodiment, flash memory 28 has been used as the external storage unit. This flash memory 28 is removably provided with respect to the image taking device body 2.

An I/O port 31 for carrying out exchange of data between the system controller 20 and other components is provided in the image taking device body 2. An input unit 32 for receiving user input, and an external connection terminal group 33 for connection of external components, are provided in the I/O port 31.

The input unit 32 is made up of, for example, a release switch, zoom lever, key operation sections etc., and signals corresponding to operation of these sections are input to the system controller 20 via the I/O port 31. The system controller 20 carries out various processing and control according to the input signals. The external connection terminal group 33 is made up of a memory slot for attachment of a memory card, being an external storage unit, and connectors for connecting to an external computer. By connecting the external storage unit and a computer to this external connection terminal group 33, it is possible to carry out input and output of data via the I/O port 31.

Here, when in playback mode, the system controller 20 reads out image data constituting an object for display from the flash memory 28 or the external storage unit connected to the external connection terminal group 33, based on user instructions input to the input unit 32, and transmits the image data to the data processing circuit 25. In this way, image data of the display object is sent to the display unit driver 26, and the image is displayed on the non-volatile image display unit 16.

The system controller 20 is also configured to display on the non-volatile image display unit 16 the most recently stored image information among the image information stored in the external storage unit, at the point in time when operating mode of the image taking device body 2 is switched to playback mode.

With the digital still camera 1 constructed in this way, as described previously, by removing the lens unit 3 from the image taking device body 2, the system controller 20 switches the operating mode of the image taking device body 2 to playback mode.

Operations such as removing the lens unit 3 from the image taking device body 2 are carried out at the user's discretion when they have finished taking pictures.

It is therefore possible to switch the operating mode of the image taking device body 2 to playback mode in accordance with the user's wishes without operating an image playback button etc., by adopting this type of structure where operating mode of the image taking device body 2 is switched to playback mode upon removal of the lens unit 3 from the image taking device body 2.

In this way, with this digital still camera 1, since it is possible to switch the operating mode of the image taking device body 2 to playback mode in accordance with the user's wishes without operating an image playback button, an operating mode switching operation of the image taking device body 2 becomes easy.

Also, in this way, with the digital still camera 1, since an image playback button is not required, there is no need to secure installation space for the image playback button in the image taking device body 2. It is therefore possible to secure installation space for various operation switches 13. By doing this, with this digital still camera 1 it is possible to maintain operability without miniaturizing the various operating switches 13 while attempting to additionally reduce the size of the image taking device body 2, and to expect improved operability with imaginative layout of various operating switches 13.

Also, with this digital still camera 1, as described above, by rotating the lens unit 3 relative to the image taking device body 2 in a state where the lens unit 3 is attached to the image taking device body 2, the system controller 20 switches the operation modes of the image taking device body 2.

In this way, it is possible to perform switching of the operating mode of the image taking device body 2 without operating a mode changing switch etc. Specifically, with this digital still camera 1 it is possible to also omit the mode changing switch.

Here, in the case of taking pictures with the image taking device, confirmation as to whether or not the acquired image information is good is generally carried out immediately after taking pictures. Specifically, among the image information stored in the storage unit of the image taking device, the frequency of browsing the most recently stored image information is high.

With this digital still camera 1, therefore, the system controller 20 is configured to display on the non-volatile image display unit 16 the most recently stored image information among the image information stored in the external storage unit, at the point in time when operating mode of the image taking device body 2 is switched to playback mode.

In this way, when the operating mode of the image taking device body 2 is switched to playback mode, image information that has an extremely high frequency of browsing is displayed first. As a result, in many cases it is possible to omit a selection operation for image information that will be displayed in playback mode, and it is possible to simplify the operation of the image taking device body 2.

Also, with this embodiment, it is possible to perform operating mode changing of the image taking device body 2 by causing relative rotation of the lens unit 3, about its optical axis, with respect to the image taking device body 2. In this way, since it is possible to perform changing of the operating mode of the image taking device body 2 without shifting the optical axis of the lens unit 3, it is possible to take pictures immediately when transferring to picture taking mode.

Also with this digital still camera 1, as described above, it is possible to activate the operating modes of the image taking device body 2 by operating the lens unit 3 that occupies a comparatively large volume in the device overall and is capable of being easily discriminated by touch. It is therefore possible, with this digital still camera 1, to rapidly perform operation mode switching of the image taking device body 2 compared to the case, for example, where a mode changing switch is operated after visually confirming the position of the switch, or operating the mode changing switch by touch.

Also, when attaching the lens unit 3 to the image taking device body 2, the user holds the image taking device body 2 and the lens unit 3 in separate hands. Therefore, after carrying out an operation to attach the lens unit 3 to the image taking device body 2, the user can speedily cause relative rotation of the image taking device body 2 and the lens unit 3 without repositioning the digital still camera 1. Specifically, the user can perform switching to a desired operating mode seamlessly with the operation of attaching the lens unit 3 to the image taking device body 2.

With this digital still camera 1, therefore, compared to the case where the digital still camera 1 is picked up after attaching the lens unit 3 to the image taking device body 2 and then operating an mode change switch etc. it is possible to smoothly carry out the operation of the digital still camera 1.

Also, with this digital still camera 1, the removal detection unit D1 is configured to detect removal of the lens unit 3 from the image taking device body 2 based on an on/off state of the first detection switch SW1 provided in the image taking device body 2 at a position facing the lens unit 3 at the time of attachment of the lens unit 3 to the image taking device body 2.

In this way, since removal of the lens unit 3 from the image taking device body 2 is detected based on the on/off state of the first detection switch SW1, the structure of the removal detection unit D1 is simplified and the manufacturing cost is reduced.

Also, the first detection switch SW1 is provided in the image taking device body 2 at a position facing the lens unit 3 at the time of attachment of the lens unit 3 to the image taking device body 2. Specifically, the first detection switch SW1 is provided inside the image taking device body 2, at a position obscured by the lens unit 3 at the time of attachment of the lens unit 3 (dead space). Therefore, even if the first detection switch SW1 is provided, no installation space for other operation switches 13 is sacrificed in the image taking device body 2, and it is possible to maintain operability.

### SECOND EMBODIMENT

A second embodiment will be described in the following.

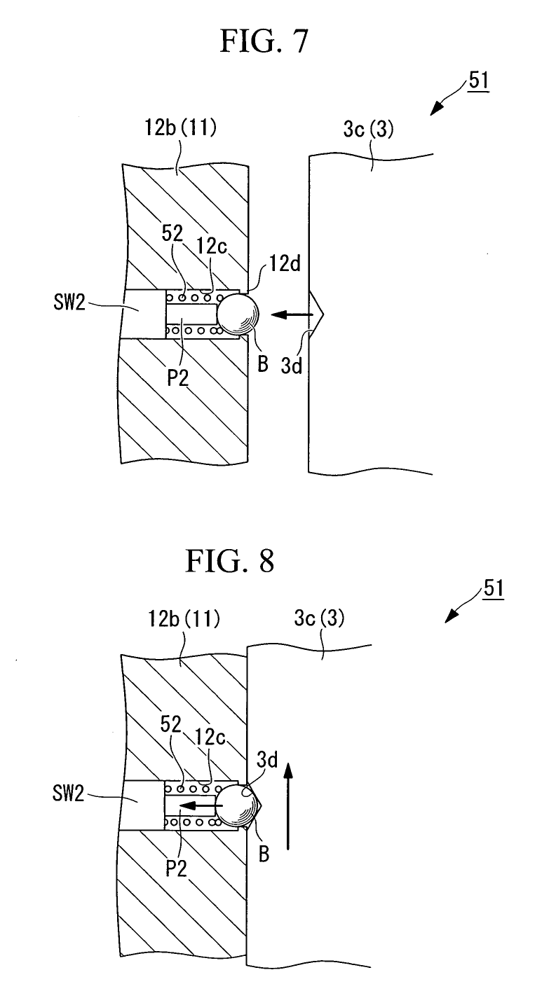

As shown in FIG. 7 to FIG. 9, a digital still camera 51 is mainly the digital still camera 1 shown in the first embodiment using a displacement detection unit D4 instead of the displacement detection unit D2. In the following, structures that are the same as in the first embodiment 1 use the same reference numerals, and detailed description thereof will be omitted.

With the digital still camera 51 the roller R and the rotation detection unit D3 constituting the displacement detection unit D2 are eliminated from the section to be operated P1 of the first detection switch SW1. Instead, a second detection switch SW2 whose on/off state is changed by relative rotation of the lens unit 3 with respect to the image taking device body 2 in a state attached to the image taking device body 2 is provided in the image taking device body 2. Also, with the digital still camera 51, the system controller 20 is configured to detect relative rotation of the lens unit 3 with respect to the image taking device body 2 based on the on/off state of the second detection switch SW2.

Specifically, with this digital still camera 51, the second detection switch SW2 and the system controller 20 constitute the displacement detection unit D4.

With this embodiment, the second detection switch SW2 is constructed using a push switch provided in a stepped section 12b formed at a rear end of the expanded diameter section 12a, inside the opening section 12 of the image taking device body 2. A containment hole 12c opening towards the opening direction of the opening section 12 is provided in the stepped section 12b. The second detection switch SW2 is housed inside the containment hole 12c so that the section to be operated P2 is positioned in the opening direction of the containment hole 12c (that is, the opening direction of the opening section 12).

A ball B is arranged inside the containment hole 12c, between the section to be operated P2 of the second detection switch SW2 and the opening end of the containment hole 12c. Also, a reduced diameter section 12d is provided at the opening end of the containment hole 12c. The inner diameter of the reduced diameter section 12d is a slightly smaller diameter than the outer diameter of the ball B. In this manner, the ball B is permitted to partially protrude from the opening end of the containment hole 12C, while being held inside the containment hole 12c.

A biasing member 52 for urging the ball B towards the opening end of the containment hole 12c is also provided inside the containment hole 12c. In this embodiment, a coil spring has been used as the biasing member 52.

In this way, as long as the ball B is not subjected to external force, it is held in a state pressed to the reduced diameter section 12d of the containment hole 12c. In a state where the ball B is pressed to the opening end of the containment hole 12c in this way, part of the ball B projects further to the opening end side of the opening section 12 than the surface of the stepped section 12b.

The second detection switch SW2 is not operated in a state where the ball B is pressed to the opening end side of the containment hole 12c in this way, and when the ball B is pushed back to substantially the same position as the surface of the containment hole 12c the section to be operated P2 is pushed more deeply into the containment hole 12c together with the ball B, and the second detection switch SW2 is operated (the on/off state is switched).

On the other hand, an indented section 3d is provided in the leading surface of the attachment section 3c of the lens unit 3. With this embodiment, the inner surface of the indented section 3d is made a conical inner surface with the diameter becoming larger towards the leading surface of the attachment section 3c.

Also, a guide member (not shown) for regulating the attitude of the lens unit 3 with respect to the casing 11, when attaching the lens unit 3 to the casing 11, is provided in at least one of the casing 11 and the lens unit 3.

In this manner, the lens unit 3 is only capable of being attached to the casing 11 in a state oriented about its optical axis, with the indented section 3d oriented towards the containment hole 12c provided inside the opening section 12 of the casing 11.

In the following, an operating method for the digital still camera 51 constructed in this way will be described.

With this digital still camera 51 also, the power supply of the image taking device body 2 is turned on by attachment of the lens unit 3 to the image taking device body 2.

Here, as described above, when the lens unit 3 is attached to the image taking device body 2, then as shown in FIG. 7 the indented section 3d of the lens unit 3 faces the containment hole 12c provided inside the opening section 12 of the casing 11.

Therefore, at the point in time when attachment of the lens unit 3 to the image taking device body 2 is complete, the part of the ball B that is projecting further than the surface of the stepped section 12b of the opening section 12 is contained inside the indented section 3d of the lens unit 3,

In this state, since there is external force other than the urging force of the biasing member 52 applied to the ball B, the ball B is held in a state pushed to the opening end of the containment hole 12c.

Here, with this embodiment, the system controller 20 is set so that the operating mode of the image taking device body 2 is made photographing mode in a state where the section to be operated P2 of the displacement detection unit D4 is not being operated. In this way, at the point in time where the lens unit 3 is attached to the image taking device body 2, since the image taking device body 2 is in photographing mode it is possible to rapidly start taking pictures.

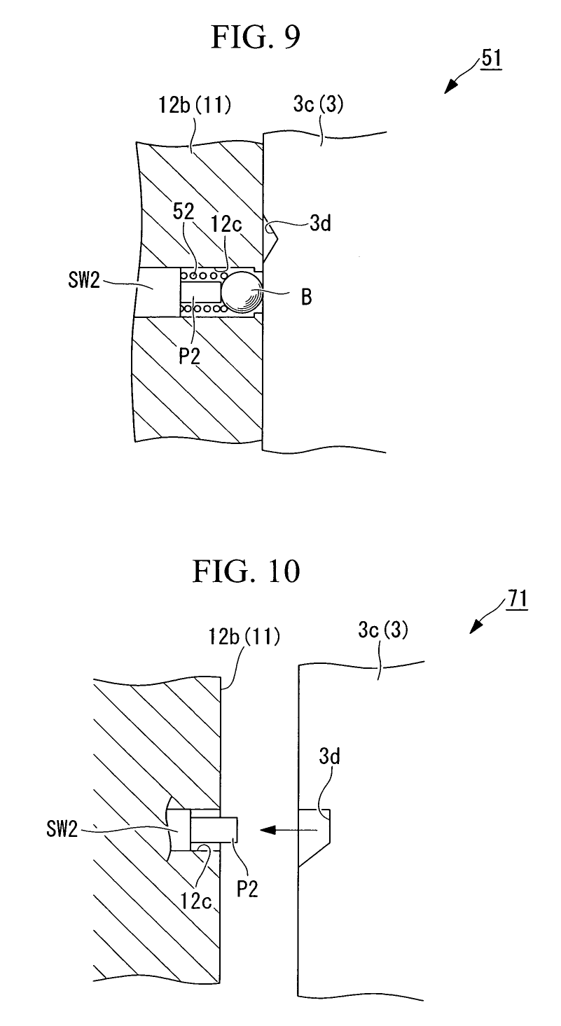

Next, by relatively moving the lens unit 3 with respect to the image taking device body 2, then as shown in FIG. 9 the indented section 3d of the lens unit 3 is moved away from the position facing the containment hole 12c provided inside the opening section 12 of the casing 11.

In this state, the ball B is pressed back inside the containment hole 12c by the leading surface of the attachment section 3c of the lens unit 3. In this way, the section to be operated P2 pushed more deeply into the containment hole 12c together with the ball B, and the second detection switch SW2 is operated.

With this embodiment, the system controller 20 is set so that the operating mode of the image taking device body 2 is made playback mode in a state where the second detection switch SW2 is operated.

As described above, the ball B has only a part projecting from the containment hole 12c, and the inner surface of the indented section 3d is a conical inner surface that expands in diameter approaching the leading surface of the attachment section 3c. In this manner, when the lens unit 3 is caused to move relative to the image taking device body 2, since the ball B is smoothly contained inside the containment hole 12c without getting caught on the inner surface of the indented sections 3d, it is possible to smoothly carry out a mode change operation

Then, by relatively moving the lens unit 3 with respect to the image taking device body 2, so that the indented section 3d of the lens unit 3 again faces the containment hole 12c provided inside the opening section 12 of the casing 11, part of the ball B is again contained inside the indented section 3d of the lens unit 3. In this way, the operation of the second detection switch SW2 is released and the operating mode of the image taking device body 2 is again set to photographing mode.

With the digital still camera 51 constructed in this way, as described above, since detection of relative rotation of the lens unit 3 with respect to the image taking device body 2 is carried out based on the on/off state of the second detection switch SW2, the structure of the displacement detection unit is simplified and the manufacturing cost is reduced.

Also, the second detection switch SW2 is provided in the image taking device body at a position facing the lens unit 3 at the time of attachment of the lens unit 3 to the image taking device body 2. Specifically, the second detection switch SW2 is provided inside the image taking device body 2, at a position obscured by the lens unit 3 at the time of attachment of the lens unit 3 (dead space). Therefore, even if the second detection switch SW2 is provided, no installation space for other operation switches 13 is sacrificed in the image taking device body 2, and it is possible to maintain operability.

Here, it is also possible to have a structure where a plurality of second detection switches SW2 are provided in the image taking device body 2, with an on/off pattern of these second detection switches SW2 being changed in accordance with amount of relative rotation of the lens unit 3 with respect to the image taking device body 2, and the displacement detection unit D4 detects relative rotation of the lens unit 3 with respect to the image taking device body 2 based on the on/off pattern of these second detection switches SW2.

In this case, a plurality of on/off patterns of the second detection switches SW2 are prepared, and it is possible to carry out switching of operating modes between three or more operating modes by making respective operating modes correspond to each pattern.

### THIRD EMBODIMENT

A third embodiment will be described in the following.

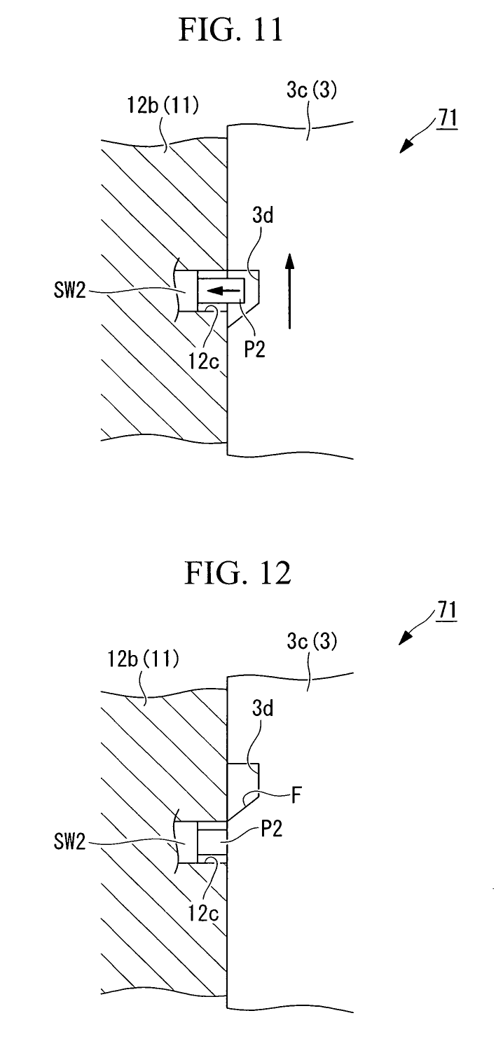

As shown in FIG. 10 to FIG. 12, a digital still camera 71 is mainly the digital still camera 51 shown in the second embodiment, using a displacement detection unit D5 instead of the displacement detection unit D4. In the following, structures that are the same as in the second embodiment use the same reference numerals, and detailed description thereof will be omitted.

With the digital still camera 71 of this embodiment, instead of providing the ball B and the biasing member 52 inside in the containment hole 12c, the second detection switch SW2 is provided so that part of the section to be operated P2 projects from the containment hole 12c.

The second detection switch SW2 is not operated in a state where the section to be operated P2 projects from the containment hole 12c (a state where the section to be operated P2 projects further than the surface of the stepped section 12b), and is only operated (the on/off state switched) when the tip of the section to be operated P2 is pushed back to substantially the same position as the surface of the stepped section 12b.

With this embodiment, this second detection switch SW2 and the system controller 20 constitute the displacement detection unit D5.

Also, with this embodiment, the inner surface of the indented section 3d provided at the leading surface of the attachment section 3c of the lens unit 3, at a position where the section to be operated P2 of the second detection switch SW2 is received when the lens unit 3 is moved relative to the image taking device body 2, is made an inclined surface F that is further away from the center of the indented section 3d approaching the leading surface of the attachment section 3c.

In this manner, when the lens unit 3 is moved relative to the image taking device body 2, since the section to be operated P2 is smoothly contained inside the containment hole 12c without getting caught on the inner surface of the indented section 3d, it is possible to smoothly carry out a mode change operation

According to the digital still camera 71, since structure of the displacement detection unit is further simplified, it is possible to reduce manufacturing costs.

With the above-described embodiment, an example of an image taking device with removable optical unit applied to a digital still camera has been described. However, this is not limiting, and it is also possible to apply the image taking device with a removable optical unit to various cameras such as a camera using photographic film, an instant camera using instant film, or a video camera.

1. An image taking device having a removable optical unit, comprising:
an image taking device body;
an optical unit that is removable with respect to the image taking device body;
a removal detection unit for detecting removal of the optical unit from the image taking device body; and
a control unit for controlling operation of the image taking device body, wherein
the image taking device body is provided with a storage unit for storing acquired image information and an image display unit, and is provided with an image playback function for displaying image information on the image display unit; and
the control unit switches an operating mode of the image taking device body to playback mode when removal of the optical unit from the image taking device body has been detected by the removal detection unit.

2. An image taking device having a removable optical unit, comprising:
an image taking device body;
an optical unit that is removable with respect to the image taking device body;
a removal detection unit for detecting removal of the optical unit from the image taking device body; and
a control unit for controlling operation of the image taking device body, wherein
the image taking device body comprises a storage section for storing acquired image information, and
an image display section for displaying the image information stored in the storage unit, and
the control unit controls the storage unit and the image display unit when removal of the optical unit from the image taking device body has been detected by the removal detection unit, so as to display the image information stored in the storage unit on the image display unit.

3. The image taking device with removable optical unit of claim 1, wherein, among the image information stored in the storage unit, the control unit displays the most recently stored image information on the image display unit at the point in time when removal of the optical unit from the image taking device body has been detected by the removal detection unit.

4. The image taking device with a removable optical unit of claim 1, wherein the removal detection unit has a first detection switch, provided in the image taking device body at a position facing the optical unit at the time of attachment of the optical unit to the image taking device body, that is operated when the optical unit is attached to the image taking device body to perform ON/OFF switching.

5. The image taking device with a removable optical unit of claim 1, wherein the optical unit is rotated with respect to the image taking device body in a state attached to the image taking device body,
a displacement detecting unit is provided for detecting relative rotation of the optical unit with respect to image taking device body in a state attached to the image taking device body, and
the displacement detecting unit detects one of at least information for relative rotation amount and rotation direction of the optical unit with respect to the image taking device body.

6. The image taking device with a removable optical unit of claim 5, wherein, the displacement detection unit has
a roller that contacts the optical unit in a state where the optical unit is attached to the image taking device body, and rotates together with relative rotation of the optical unit with respect to the image taking device body, and
a rotation detection unit for detecting at least one of information of rotation amount and rotation direction of the roller, and wherein
the displacement detecting unit detects relative rotation of the optical unit with respect to the image taking device body based on information on at least one of rotation amount and rotation direction of the roller detected by the rotation detection unit.

7. The image taking device with a removable optical unit of claim 5, wherein the displacement detection unit has a second detection switch for performing on/off switching by causing relative rotation with respect to the image taking device body in a state where the optical unit is attached to the image taking device body, and
the displacement detecting unit detects relative rotation of the optical unit with respect to the image taking device body based on the on/off state of the second detection switch.

8. The image taking device with removable optical unit of claim 1, wherein the image taking device body has a timer for measuring time, and
the control unit is configured to turn the power supply of the image taking device body off at a point in time where the timer has measured a reference time from the time when removal of the optical unit from the image taking device body was detected by the removal detection unit.

9. The image taking device with removable optical unit of claim 1, wherein the image display unit is a non-volatile image display unit for holding display content when power is not being supplied to the image display unit.

10. The image taking device with removable optical unit of claim 2, wherein, among the image information stored in the storage unit, the control unit displays the most recently stored image information on the image display unit at the point in time when removal of the optical unit from the image taking device body has been detected by the removal detection unit.

11. The image taking device with a removable optical unit of claim 2, wherein the removal detection unit has a first detection switch, provided in the image taking device body at a position facing the optical unit at the time of attachment of the optical unit to the image taking device body, that is operated when the optical unit is attached to the image taking device body to perform ON/OFF switching.

12. The image taking device with a removable optical unit of claim 2, wherein the optical unit is rotated with respect to the image taking device body in a state attached to the image taking device body,
a displacement detecting unit is provided for detecting relative rotation of the optical unit with respect to image taking device body in a state attached to the image taking device body, and
the displacement detecting unit detects one of at least information for relative rotation amount and rotation direction of the optical unit with respect to the image taking device body.

13. The image taking device with a removable optical unit of claim 12, wherein, the displacement detection unit has
a roller that contacts the optical unit in a state where the optical unit is attached to the image taking device body, and rotates together with relative rotation of the optical unit with respect to the image taking device body, and
a rotation detection unit for detecting at least one of information of rotation amount and rotation direction of the roller, and wherein
the displacement detecting unit detects relative rotation of the optical unit with respect to the image taking device body based on information on at least one of rotation amount and rotation direction of the roller detected by the rotation detection unit.

14. The image taking device with a removable optical unit of claim 12, wherein the displacement detection unit has a second detection switch for performing on/off switching by causing relative rotation with respect to the image taking device body in a state where the optical unit is attached to the image taking device body, and
the displacement detecting unit detects relative rotation of the optical unit with respect to the image taking device body based on the on/off state of the second detection switch.

15. The image taking device with removable optical unit of claim 2, wherein the image taking device body has a timer for measuring time, and
the control unit is configured to turn the power supply of the image taking device body off at a point in time where the timer has measured a reference time from the time when removal of the optical unit from the image taking device body was detected by the removal detection unit.

16. The image taking device with removable optical unit of claim 2, wherein the image display unit is a non-volatile image display unit for holding display content when power is not being supplied to the image display unit.
